(19) United States
(12) Patent Application Publication
(10) Pub. No.: US 2020/0093151 A1
(43) Pub. Date: Mar. 26, 2020

(54) EMULSION OF TRIGLYCERIDE OIL IN GLYCERIN WITH LECITHIN

(71) Applicant: Bioriginal Food & Science Corp., Saskatoon (CA)

(72) Inventor: Fredric James Nugent, Saskatoon (CA)

(73) Assignee: Bioriginal Food & Science Corp.

(21) Appl. No.: 16/141,782

(22) Filed: Sep. 25, 2018

(51) Int. Cl. A23D 7/01; A23D 7/04; A23L 33/115; A23L 33/105; A23L 33/15

(52) U.S. Cl. CPC A23D 7/011; A23D 7/04; A23L 33/115; A23L 33/105; A23L 33/15; A23V 2002/00; A23V 2300/31; A23V 2250/1842; A23V 2250/1846; A23V 2250/194; A23V 2250/21; A23V 2250/6406; A23V 2300/24; A23V 2200/222

(57) ABSTRACT

A triglyceride oil-in-glycerin emulsion with triglyceride oil in an amount equal to between forty and seventy percent of the emulsion on a weight basis, glycerin in an amount equal to between twenty and sixty percent of the emulsion on a weight basis, and lecithin in an amount equal to between one and ten percent of the emulsion on a weight basis. The lecithin has a hydrophilic lipophilic balance value in the range of four to seven and contains at least ten percent phosphatidylcholine on a weight basis. The free fatty acids in the emulsion have an acid value of less than two. The emulsion does not contain any preservatives.

### BACKGROUND OF THE INVENTION

### 1. Field of the Invention

This invention relates to a novel triglyceride oil-in-glycerin emulsion having triglyceride oil, glycerin, and lecithin in an emulsion.

### 2. Description of the Related Art

Recently, food industry certifications are being applied to many food and dietary supplement businesses—in particular, Organic, GMO verified, Vegan, Vegetarian, Gluten-free, Halal, Kosher and Paleo. Although each of these certifications has many different requirements, a common requirement among all these certifications is the exclusion of synthetic ingredients or synthesis with chemical reagents. Only natural ingredients, naturally derived and natural processing are allowed with these certifications. Synthetic or artificial materials such as emulsifiers, bioactives, preservatives, colors, flavors and solvents are not allowed.

Additionally, in food businesses, there is an increasing demand for preservative-free emulsions that have not been subjected to chemical preservatives or severe heat treatments, but at the same time have acceptable emulsion properties. To prepare these emulsions, companies face a number of conflicting requirements. If the product contained no water, the use of chemical preservatives or heat treatments to inhibit the growth of unacceptable microorganisms would be avoided.

The type of emulsion, oil-in water (O/W) or water-in-oil (W/O), depends on the factors of the hydrophilic lipophilic balance (HLB) of emulsifier, volume fraction of both oil and water phases, and temperature. In 1913, Bancroft¹ found that an emulsifier with a low HLB value up to about eight is preferentially soluble in oil and results in the formation of a W/O emulsion. The reverse situation occurs with emulsifiers of high HLB value of greater than eight to 16 create O/W emulsions. The effect of increasing the volume fraction of the dispersed phase in either an O/W or W/O emulsion can cause phase separation/inversion of the emulsion, resulting in the dispersed phase becoming the continuous phase and the continuous phase now becoming the dispersed phase.

Temperature influences the droplet disruption, improving the emulsifier ability to create an emulsion, especially water-in-oil emulsion.

Similar to O/W emulsions, triglyceride oil-in-glycerin emulsions that provide for increased amounts of triglyceride oils to be incorporated and reduce the hydrolysis of fatty acids from these triglyceride oils would provide an increased delivery of the triglyceride oil. Design of these triglyceride oil-in-glycerin emulsions is a departure from traditional methods of O/W emulsions. Transferring concepts of emulsion technology to a family of triglyceride oil-in-glycerin emulsions presents a variety of interesting and unique properties of more palatable emulsions and reduced hydrolysis of triglyceride oils.

Descriptions of combinations of oil-in-glycerin emulsions, as well as methods for their formulation, are provided in U.S. Pat. No. 8,187,615 (Friedman, 2012), U.S. Pat. No. 7,393,548 (Friedman, 2008), U.S. Pat. No. 2,463,738 (Bernhart, 1949), and U.S. Pat. No. 6,544,530 (Friedman, 2003) and referenced cited therein. Each of these patent references is discussed below.

The '615 patent discloses a composition for non-hydrous emulsion wherein the emulsifier is a high HLB value synthetic surface-active agent. Up to 40% oil is incorporated into the oil-in-glycerin emulsion. The emulsion is prepared by heating the two phases to 80° C.-100° C. A bioactive is dissolved in the oil phase prior to making the oil-in-glycerin emulsion.

The '548 patent provides a method for facilitating stratum corneum and dermal penetration of at least one bioactive agent having at least one hydrophobic moiety, the method comprising administering a topical cosmetic or pharmaceutical composition in the form of an oil-in-glycerin nano-emulsion. A synthetic emulsifier and stabilizing agent is selected from the high HLB value group consisting of saccharide esters or ethers, alkylglucosides, sucrose esters, and sorbitan esters. Up to 40% oil is incorporated into the oil-in-glycerin emulsion. The emulsion is prepared by heating the oil and glycerin phases to 70° C. At least one bioactive compound is included in the oil phase before making the oil-in-glycerin emulsion.

The '738 patent discloses a stable, substantially oil-in-glycerin emulsion composition comprising an oil, glycerol and a small amount of a high HLB value proteinaceous prolamine as an emulsifier and stabilizing agent. Up to 50% oil is incorporated into the oil-in-glycerin emulsion. Preparation of the oil-in-glycerin emulsion is done by heating to 45° C. to 140° C. The oil-in-glycerin emulsion may contain water-soluble and fat-soluble vitamin bioactives.

The '530 patent discloses a composition comprising an oil-in-glycerin emulsion containing at least one oil, at least one emulsifier and glycerin. The high HLB value, synthetic emulsifier is made from condensation of vegetable monosaccharide, disaccharide or polysaccharide and a vegetable fatty acid. Up to 40% oil is used in the oil-in-glycerin emulsion. After heating both oil and glycerin to 70° C. separately, the two phases are combined into oil-in-glycerin emulsion. The oil-in-glycerin contains at least one essential oil bioactive.

The present invention is an emulsion comprised of lecithin (which is a low HLB value emulsifier) and two immiscible liquids. The lecithin contains about 20% phosphatidylcholine, and the immiscible liquids are triglyceride oil and glycerin. These three components combine to create a triglyceride oil-in-glycerin emulsion. The present invention differs from the prior art in at least the following respects:
(1) An emulsifier (lecithin) with a low HLB value rather than a high HLB value is used to prepare a triglyceride oil-in-glycerin emulsion.
(2) As illustrated by the '530 patent, prior art teaches that emulsifiers such as “phospholipids [lecithin] may be added to oil-in-glycerin emulsions; however, phospholipids alone are not sufficient emulsifiers to stabilize many oil-in-glycerin emulsions.” In the present invention, lecithin alone is used as an emulsifier to create a triglyceride oil-in-glycerin emulsion.
(3) The lecithin of the present invention must contain sufficient amounts of phosphatidylcholine to be effective in emulsifying a triglyceride oil-in-glycerin emulsion. Phosphatidylcholine has not been described in triglyceride oil-in-glycerin prior art.
(4) In the present invention, up to 70% of triglyceride oil is efficiently incorporated into a triglyceride oil-in-emulsion; only up to 50% triglyceride has been described in the prior art of triglyceride oil-in glycerin emulsion.
(5) A temperature above 60° C. and a slow addition of triglyceride oil under high-shear mixing are employed in manufacturing the present invention. In the prior art, triglyceride oil-in-glycerin emulsions are prepared by simply heating to 45° C. to 145° C. a blend of oil, glycerin and emulsifier with continuous mixing.
(6) In the present invention, a natural emulsifier (lecithin) is used in a triglyceride oil-in-glycerin emulsion; the prior art uses blends of synthetic emulsifiers or blends of natural and synthetic emulsifiers.
(7) In the present invention, the triglyceride oil-in-glycerin emulsion is made from completely natural ingredients; only synthetic materials or a combination of synthetic and natural ingredients are taught in the prior art.

A primary object of the present invention is to provide a W/O, low HLB value emulsifier that can be used to create a triglyceride oil-in-glycerin emulsion. Another object of the invention is to provide a method for processing a triglyceride oil-in-glycerin emulsion that results in a significant increase in the incorporated triglyceride oil thereof. Another object of this invention is to provide a triglyceride oil-in-glycerin that renders the composition self-preserving. Another object of the invention is to provide a composition of both lipophilic and hydrophilic phases that can efficiently accommodate both lipophilic and hydrophilic bioactives. Another object of the invention is to provide a method for manufacturing a triglyceride oil-in-glycerin emulsion that can be conducted on a relatively large scale (see Example 6).

### BRIEF SUMMARY OF THE INVENTION

The present invention is a triglyceride oil-in-glycerin emulsion comprising: triglyceride oil in an amount equal to between forty and seventy percent of the emulsion on a weight basis; glycerin in an amount equal to between twenty and sixty percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives. In a preferred embodiment, the triglyceride oil is selected from the group consisting of almond oil, borage oil, coconut oil, black currant seed oil, chia seed oil, camelina oil, canola oil, echium oil, evening primrose oil, flaxseed oil, hemp seed oil, sacha inchi oil, high GLA safflower oil, liquid coconut oil, pumpkin seed oil, palm oil, palm kernel oil, perilla oil, peanut oil, safflower oil, soybean oil, sunflower oil, walnut oil and wheat germ oil and combinations thereof. In another preferred embodiment, the triglyceride oil is selected from an animal source of anchovies, catfish, cod, flounder, grouper, halibut, herring, mackerel, pollock, swordfish, salmon, sardines, seal oil, snapper and tuna and combinations thereof. In another preferred embodiment, the triglyceride oil is selected from an algae source of docosahaexanoic acid rich oil and eicosapentaenoic acid rich oil and combinations thereof. In another preferred embodiment, the triglyceride oil is selected from a microbial source of alpha linolenic acid rich oil, docosahexaenoic acid rich oil, eicosapentaenoic acid rich oil, gamma linolenic acid rich oil and linoleic acid rich oil and combinations thereof. In another preferred embodiment, the triglyceride oil is selected from a synthetic source of re-esterified oil, inter-esterified mixtures of oils, medium chain triglyceride oil, plant oil concentrates and animal oil concentrates and combinations thereof. In another preferred embodiment, the triglyceride oil is selected from a genetically modified organisms source of borage oil, canola oil, corn oil, evening primrose oil, flax oil, safflower oil, soybean oil, and sunflower oil and combinations thereof.

In a preferred embodiment, the lecithin is selected from the group consisting of crude lecithin, compounded lecithin, enzyme-modified lecithin, chemically modified lecithin, and refined lecithin. In another preferred embodiment, the lecithin is derived from plant sources including sunflower, soy, corn, cottonseed, marine, rapeseed and canola. In another preferred embodiment, the lecithin is de-oiled lecithin powder from sunflower containing approximately 97% phospholipids, wherein approximately 20% of the phospholipids are phosphatidylcholine. In another preferred embodiment, the lecithin is selected from the group consisting of phosphatidylcholine, phosphatidylethanolamine, phosphatidylinositol, phosphatidic acid, phosphatidylserine, sphingomyelin and glycolipids.

In an alternate embodiment, the present invention is a triglyceride oil-in-glycerin emulsion comprising: triglyceride oil in an amount equal to between forty-five and sixty-five percent of the emulsion on a weight basis; glycerin in an amount equal to between twenty-five and fifty-five percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives. In an alternate embodiment, the present invention is a triglyceride oil-in-glycerin emulsion comprising: triglyceride oil in an amount equal to between fifty and sixty percent of the emulsion on a weight basis; glycerin in an amount equal to between thirty and fifty percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives.

In an alternate embodiment, the present invention is a triglyceride oil-in-glycerin emulsion comprising: triglyceride oil in an amount equal to between forty and seventy percent of the emulsion on a weight basis; glycerin in an amount equal to between twenty-five and fifty-five percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives. In an alternate embodiment, the present invention is a triglyceride oil-in-glycerin emulsion comprising: triglyceride oil in an amount equal to between forty and seventy percent of the emulsion on a weight basis; glycerin in an amount equal to between thirty and fifty percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives.

In an alternate embodiment, the present invention is a triglyceride oil-in-glycerin emulsion comprising: triglyceride oil in an amount equal to between forty and seventy percent of the emulsion on a weight basis; glycerin in an amount equal to between twenty and fifty-five percent of the emulsion on a weight basis; and lecithin in an amount equal to between 2.5 and 7.5 percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives. In an alternate embodiment, the present invention is a triglyceride oil-in-glycerin emulsion comprising: triglyceride oil in an amount equal to between forty and seventy percent of the emulsion on a weight basis; glycerin in an amount equal to between twenty-five and fifty percent of the emulsion on a weight basis; and lecithin in an amount equal to between four and six percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives.

In an alternate embodiment, the present invention is a triglyceride oil-in-propylene glycol emulsion comprising: triglyceride oil in an amount equal to between forty and seventy percent of the emulsion on a weight basis; propylene glycol in an amount equal to between twenty and sixty percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives. In an alternate embodiment, the present invention is a triglyceride oil-in-polyethylene glycol emulsion comprising: triglyceride oil in an amount equal to between forty and seventy percent of the emulsion on a weight basis; polyethylene glycol in an amount equal to between twenty and sixty percent of the emulsion on a weight basis; and lecithin in an amount equal to between one and ten percent of the emulsion on a weight basis; wherein the lecithin has a hydrophilic lipophilic balance value in the range of four to seven; wherein the lecithin contains at least ten percent phosphatidylcholine on a weight basis; wherein the free fatty acids in the emulsion have an acid value of less than two; and wherein the emulsion does not contain any preservatives.

In a preferred embodiment, the ratio of triglyceride oil to glycerin on a weight basis is in the range of 0.5 to 2.5:1. In another preferred embodiment, the ratio of triglyceride oil to glycerin on a weight basis is 1.6:1. In another preferred embodiment, the ratio of lecithin to glycerin on a weight basis is in the range of 0.05 to 0.30:1. In another preferred embodiment, the ratio of lecithin to glycerin on a weight basis is 0.08:1.

The present invention preferably further comprises at least one bioactive ingredient selected from plant, animal and/or synthetically produced sources. The bioactive is preferably selected from the group consisting of medium chain fatty acids, omega-3 fatty acids, omega-6 fatty acids, omega-7 fatty acids, omega-9 fatty acids, amino acids, vitamins, cannabinoids, herbals and other botanicals, and concentrates, metabolites, constituents, extracts and derivatives thereof. Alternately, the bioactive is a dietary substance for use by man to increase total dietary intake.

The present invention is also a method for manufacturing a triglyceride oil-in-glycerin emulsion comprising the steps of: providing respective quantities of triglyceride oil and glycerin in a ratio of 2.5 to 0.5:1 on a weight basis; mixing lecithin containing at least ten percent phosphatidylcholine into the triglyceride oil; heating the lecithin-triglyceride oil mixture to a temperature in the range of 60° C. to 120° C.; heating the glycerin to a temperature in the range of 60° C. to 120° C.; adding the lecithin-triglyceride oil mixture to the glycerin over at least 25 minutes while stirring at successively higher speeds with a high-shear mixer; maintaining the lecithin-triglyceride oil-glycerin mixture at a temperature in the range of 60° C. to 120° C. during the mixing step; and cooling the lecithin-triglyceride oil-glycerin mixture to below 40° C. and allowing the mixture to stand undisturbed for a period of time sufficient to allow a stable emulsion to form. In one embodiment, the present invention further comprises the step of mixing the lecithin-triglyceride oil-glycerin mixture for at least ten minutes to allow for oil droplet size uniformity.

In a preferred embodiment, the step of adding the lecithin-triglyceride oil mixture to the glycerin over at least 25 minutes while stirring at successively higher speeds with a high-shear mixer comprises: stirring the lecithin-triglyceride oil-glycerin mixture for approximately four minutes at a mixer speed of 500 rpm; stirring the lecithin-triglyceride oil-glycerin mixture for approximately three minutes at a mixer speed of 1000 rpm; stirring the lecithin-triglyceride oil-glycerin mixture for approximately three minutes at a mixer speed of 1500 rpm; and stirring the lecithin-triglyceride oil-glycerin mixture for approximately 15 minutes at a mixer speed of 3000 rpm. In a preferred embodiment, the step of adding the lecithin-triglyceride oil mixture to the glycerin over approximately 25 to 30 minutes while stirring at successively higher speeds with a high-shear mixer comprises: using a high-shear mixer fitted with impeller sizes from 0.05 to 0.80 meter; and running the mixer at impeller tip speeds from one to ten meters per second until the mixture thickens into a homogeneous triglyceride oil-in-glycerin emulsion.

In an alternate embodiment, the present invention is a method for manufacturing a triglyceride oil-in-propylene glycol emulsion comprising the steps of: providing respective quantities of triglyceride oil and propylene glycol in a ratio of 2.5 to 0.5:1 on a weight basis; mixing lecithin containing at least ten percent phosphatidylcholine into the triglyceride oil; heating the lecithin-triglyceride oil mixture to a temperature in the range of 60° C. to 120° C.; heating the propylene glycol to a temperature in the range of 60° C. to 120° C.; adding the lecithin-triglyceride oil mixture to the propylene glycol over at least 25 minutes while stirring at successively higher speeds with a high-shear mixer; maintaining the lecithin-triglyceride oil-propylene glycol mixture at a temperature in the range of 60° C. to 120° C. during the mixing step; and cooling the lecithin-triglyceride oil-propylene glycol mixture to below 40° C. and allowing the mixture to stand undisturbed for a period of time sufficient to allow a stable emulsion to form. In one embodiment, the present invention further comprises the step of mixing the lecithin-triglyceride oil-propylene glycol mixture for at least ten minutes to allow for oil droplet size uniformity.

In a preferred embodiment, the step of adding the lecithin-triglyceride oil mixture to the propylene glycol over at least 25 minutes while stirring at successively higher speeds with a high-shear mixer comprises: stirring the lecithin-triglyceride oil-propylene glycol mixture for approximately four minutes at a mixer speed of 500 rpm; stirring the lecithin-triglyceride oil-propylene glycol mixture for approximately three minutes at a mixer speed of 1000 rpm; stirring the lecithin-triglyceride oil-propylene glycol mixture for approximately three minutes at a mixer speed of 1500 rpm; and stirring the lecithin-triglyceride oil-propylene glycol mixture for approximately 15 minutes at a mixer speed of 3000 rpm. In a preferred embodiment, the step of adding the lecithin-triglyceride oil mixture to the propylene glycol over approximately 25 to 30 minutes while stirring at successively higher speeds with a high-shear mixer comprises: using a high-shear mixer fitted with impeller sizes from 0.05 to 0.80 meter; and running the mixer at impeller tip speeds from one to ten meters per second until the mixture thickens into a homogeneous triglyceride oil-in-propylene glycol emulsion.

In an alternate embodiment, the present invention is a method for manufacturing a triglyceride oil-in-polyethylene glycol emulsion comprising the steps of: providing respective quantities of triglyceride oil and polyethylene glycol in a ratio of 2.5 to 0.5:1 on a weight basis; mixing lecithin containing at least ten percent phosphatidylcholine into the triglyceride oil; heating the lecithin-triglyceride oil mixture to a temperature in the range of 60° C. to 120° C.; heating the polyethylene glycol to a temperature in the range of 60° C. to 120° C.; adding the lecithin-triglyceride oil mixture to the polyethylene glycol over at least 25 minutes while stirring at successively higher speeds with a high-shear mixer; maintaining the lecithin-triglyceride oil-polyethylene glycol mixture at a temperature in the range of 60° C. to 120° C. during the mixing step; and cooling the lecithin-triglyceride oil-polyethylene glycol mixture to below 40° C. and allowing the mixture to stand undisturbed for a period of time sufficient to allow a stable emulsion to form. In one embodiment, the present invention further comprises the step of: mixing the lecithin-triglyceride oil-polyethylene glycol mixture for at least ten minutes to allow for oil droplet size uniformity.

In a preferred embodiment, the step of adding the lecithin-triglyceride oil mixture to the polyethylene glycol over at least 25 minutes while stirring at successively higher speeds with a high-shear mixer comprises: stirring the lecithin-triglyceride oil-polyethylene glycol mixture for approximately four minutes at a mixer speed of 500 rpm; stirring the lecithin-triglyceride oil-polyethylene glycol mixture for approximately three minutes at a mixer speed of 1000 rpm; stirring the lecithin-triglyceride oil-polyethylene glycol mixture for approximately three minutes at a mixer speed of 1500 rpm; and stirring the lecithin-triglyceride oil-polyethylene glycol mixture for approximately 15 minutes at a mixer speed of 3000 rpm. In a preferred embodiment, the step of adding the lecithin-triglyceride oil mixture to the polyethylene glycol over approximately 25 to 30 minutes while stirring at successively higher speeds with a high-shear mixer comprises: using a high-shear mixer fitted with impeller sizes from 0.05 to 0.80 meter; and running the mixer at impeller tip speeds from one to ten meters per second until the mixture thickens into a homogeneous triglyceride oil-in-polyethylene glycol emulsion.

### DETAILED DESCRIPTION OF INVENTION

Prior art teaches that lecithin alone is not effective in its emulsifying capacity to produce a triglyceride oil-in-glycerin emulsion; however, significant and natural variation is possible in lecithin commercial products in terms of phosphatidylcholine, phosphatidylethanolamine, phosphatidylinositol, phosphatidic acid, phosphatidylserine, sphingomyelin and glycolipids content. The principle characteristics that determine the variations in phospholipids ratios are commercial processing variables: (1) plant source; (2) starting phospholipids ratios; (3) phospholipids concentration; (4) process separation polarities; (5) process temperature; and (6) process extraction conditions. Experimental testing conducted by the inventor used commercial lecithin mixtures in various phospholipids ratios, and lecithin containing about 20% phosphatidylcholine has proven to be unexpectedly and particularly suitable in emulsification capacity of triglyceride oil-in-glycerin emulsions.

Because lecithin alone as an emulsifier in triglyceride oil-in-glycerin is not described in the prior art, research was conducted to determine the lecithin emulsifying effectiveness, processing temperature, triglyceride oil hydrolysis, self-preserving effect, inclusion of bioactives and scale-up potential. In particular, the emulsion's dispersion into water, centrifugation testing, acid value and microbial testing were selected to determine how effective lecithin was to changes in the composition and processes of the triglyceride oil-in-glycerin emulsions.

Specifically, combining lecithin that contains about 20% of phosphatidylcholine with triglyceride oil and glycerin at a temperature of about 70° C. unexpectedly produced emulsions that were triglyceride oil-in-glycerin and not glycerin-in-triglyceride oil. W/O emulsion compositions are typically formed with low-HLB surfactants, but O/W are not; the present invention is based on the discovery that a stable triglyceride oil-in-glycerin emulsion composition can be obtained by using lecithin having an HLB of 7 or less.

The lecithin used to prepare the triglyceride-in-oil emulsion of this invention typically contains about 20% phosphatidylcholine. This particular type of lecithin, which contains about 20% phosphatidylcholine, had a significant and unexpected impact on the overall emulsification of triglyceride oil-in-glycerin. In particular, from the centrifugation testing of the triglyceride oil-in-glycerin, the destabilizing treatment of the emulsion by centrifuging at 3,000 rpm for 15 minutes at 20° C. displayed excellent emulsion suspending powers. The only limitation for destabilizing effect was a process temperature below 60° C. used to make the triglyceride oil-in-glycerin emulsion of this invention (see Example 2); in other words, the emulsion either does not form or forms but is not stable below 60° C.

In contrast to traditional O/W emulsions, the triglyceride oil-in-glycerin emulsion of the present invention has a fatty acid content (expressed as acid value) that does not change after six months of storage at room temperature. A low acid value ensures the stability of the triglyceride oil over a longer period of time. The absence of water prevents the hydrolytic reaction of triglyceride oil to free fatty acids in the emulsion (see Example 3).

Furthermore, it has been found unexpectedly that because of very low moisture levels in the triglyceride oil-in-glycerin emulsion, self-preserving properties were obtained, and microbial growth was suppressed (see Example 4). The triglyceride oil-in-glycerin using lecithin that contains about 20% phosphatidylcholine did not require any additional microbial preservatives.

Although most of the prior art is limited to emulsification of hydrophilic bioactive food components, the present invention can also accommodate dissolving and emulsifying both hydrophobic and lipophilic bioactives (see Example 5). Testing has shown that lyophilic bioactive food components, such as CoQ10, and hydrophilic bioactive food components, such as L-carnitine, can be emulsified into a single emulsion. In other words, the present invention can be advantageously employed to emulsify either hydrophilic or lipophilic bioactives or both. In the case of lipophilic bioactive food components, the substances to be emulsified are dissolved with the triglyceride oil prior to the emulsion-forming step. The hydrophilic bioactives, on the other hand, are added to the glycerin phase used to disperse the triglyceride oil.

The batch size of the triglyceride oil-in-glycerin used in any application will depend upon the scale of operation, the intensity of agitation, and other factors that will be apparent to one skilled in the art. It is contemplated that the mixer in manufacturing operations could have a range of sizes; however, tests have shown that the optimal impeller tip speed must be maintained between about one meter per second and about ten meters per second. The tip speed of the impeller employed will depend upon the shape and size of the impeller, the size of the vessel, the volume of triglyceride oil-in glycerin emulsion, and the quantity of lipid and lipophilic bioactive dissolved.

In the triglyceride oil-in-glycerin emulsion according to the present invention, the following quantities are preferred:
a) Triglyceride oils are present in an amount ranging from about 40-70 percent on a weight basis;
b) De-oiled lecithin that contains about 20 percent phosphatidylcholine is present in an amount ranging from about 1-10 percent on a weight basis; and
c) Glycerin is present in an amount ranging from about 20-60 percent on a weight basis.

The triglyceride oil as used herein means edible oil in which the components thereof are in forms of glycerol and fatty acids and esters of ethanol and fatty acids for an oral ingestion. Triglyceride oils include, but are not limited to, either natural or synthetic sources. Particularly preferred are triglyceride oils of almond oil, borage oil, coconut oil, black currant seed oil, chia seed oil, camelina oil, canola oil, echium oil, evening primrose oil, flaxseed oil, hemp seed oil, sacha inchi oil, high GLA safflower oil, liquid coconut oil, pumpkin seed oil, palm oil, palm kernel oil, perilla oil, peanut oil, safflower oil, soybean oil, sunflower oil, walnut oil and wheat germ oil and combinations thereof; from an animal source of anchovies, catfish, cod, flounder, grouper, halibut, herring, mackerel, pollock, swordfish, salmon, sardines, seal oil, snapper and tuna and combinations thereof; from an algae source of docosahaexanoic acid rich oil and eicosapentaenoic acid rich oil and combinations thereof; from a microbial source of alpha linolenic acid rich oil, docosahexaenoic acid rich oil, eicosapentaenoic acid rich oil, gamma linolenic acid rich oil and linoleic acid rich oil and combinations thereof; from a synthetic source of re-esterified oil, inter-esterified mixtures of oils, medium chain triglyceride oil, plant oil concentrates and animal oil concentrates and combinations thereof; from a genetically modified organisms source of borage oil, canola oil, corn oil, evening primrose oil, flax oil, safflower oil, soybean oil, and sunflower oil and combinations thereof. Other triglyceride oils are known by those of skill in the art. Most of the oils listed above are high in omega-3 fatty acids, omega-6 fatty acids, omega-7 fatty acids and/or omega-9 fatty acids. Other oils included in this list (for example, coconut oil, liquid coconut oil and palm kernel oil) are rapidly absorbed through the liver and rapidly converted to energy in the body.

In the present invention, the ratio of triglyceride oil to glycerin on a weight basis is preferably in the range of about 0.5 to 2.5:1; in a preferred embodiment, this ratio is about 1.6:1. The ratio of lecithin to glycerin on a weight basis is preferably in the range of about 0.05 to 0.30:1; in a preferred embodiment, this ratio is about 0.08:1. As used herein, the term “weight basis” refers to the weight of one substance in the composition relative to the weight of another substance in the composition.

The lecithin of the present invention may be selected from the group consisting of crude lecithin, compounded lecithin, enzyme-modified lecithin, chemically modified lecithin, and refined lecithin. Suitable lecithin includes plant sources such as sunflower, soy, corn, cottonseed, marine, rapeseed and canola which can form a triglyceride oil-in-glycerin emulsion. De-oiled lecithin powder from sunflower, containing a total of 97% phospholipids, with 20% of the total being phosphatidylcholine, is the preferred phospholipid. It should also be appreciated that other lecithin containing different amounts and ratios of phospholipids such as phosphatidylcholine, phosphatidylethanolamine, phosphatidylinositol, phosphatidic acid, phosphatidylserine, sphingomyelin and glycolipids would also be suitable for the practice of this invention. Although a lecithin with a high amount of phosphatidylcholine is preferred, it should also be appreciated that various amounts and ratios of phospholipid entities may be used.

Glycerin is the preferred water miscible, non-aqueous continuous phase; however, it should also be appreciated that other non-toxic, edible, synthetic liquids such as propylene glycol and polyethylene glycol would also be suitable. The amount of the liquid used will depend upon the amount of continuous phase needed in processing, the amount of lecithin, the intensity of agitation and the scale of operation. Generally, the amount of glycerin will have a range such that the amount used will ensure the lecithin adsorption to the emulsion interface does form.

The first step in manufacturing the composition of the present invention is to provide respective quantities of triglyceride oil and glycerin in a ratio on a weight basis of about 2.5 to 0.5:1 (this is before the lecithin is mixed with the triglyceride oil). Next, lecithin containing about 20% phosphatidylcholine is mixed into the triglyceride oil (“mixed-oil phase”) in a secondary vessel and heated to about 70° C.; an acceptable temperature range for this step is from about 60° C. to about 120° C. Glycerin, in a primary vessel, is also stirred and heated to about 70° C.; again, an acceptable temperature range for this step is from about 60° C. to about 120° C. Next, the mixed oil phase (that is, the lecithin combined with the triglyceride oil) is slowly added over about 25 minutes to the glycerin while stirring at 500 rpm for the first four minutes. The stirring is increased to 1000 rpm for about three minutes, increased again to 1500 rpm for another about three minutes, and increased again to 3000 rpm for about 15 minutes. During all of the stirring steps, the total mixture (that is, the triglyceride oil (which contains lecithin) and glycerin mixture) is maintained at a temperature of around 70° C.; an acceptable temperature range for this step is from about 60° C. to about 120° C. Experiments showed that if the temperature of the total mixture is decreased to 60° C. or below, the emulsion does not form (see Example 2). The emulsion is mixed for about ten more minutes for oil droplet size uniformity. The total mixture is then cooled to below 40° C. and allowed to stand undisturbed for a period of time sufficient to allow the stable emulsion to form.

A slow addition over about twenty-five (25) minutes of the triglyceride phase with increasing high-shear mixing for manufacturing was found to be the optimum in the formation of the triglyceride oil-in-glycerin emulsion. Consequently, the present invention is based on those factors which affect primarily the lecithin adsorption emulsification. In the present invention, changing the ratios and/or amounts of phospholipids like phosphatidylcholine in lecithin caused the droplet size of the oil droplet to become an independently controlled process provided there was higher temperature, slow addition and high-shear agitation present. Subsequently, increasing the temperature, slow addition and high-shear agitation was sufficient to decrease the oil droplet size and increase the stability of the emulsion.

The present invention possesses four primary features which improve the formation of triglyceride oil-in-glycerin emulsion. Lecithin containing about 20% phosphatidylcholine must be present to form small oil droplets. The increased temperature must be present to change the practical insolubility of lecithin in glycerin to slightly soluble in glycerin. Slowly adding the triglyceride oil mixture allows the lecithin to find and adsorb to the interface between the oil and glycerin. The high-shear agitation with a simple impeller allows the lecithin to adsorb to interface of the triglyceride oil and glycerin.

In the present invention, the purpose of this high-shear mixer is to mechanically reduce the particle size of the large triglyceride oil droplets. Using other commercially available mixers fitted with various size impellers, run at slower or higher impeller speeds, and mixing at lower and higher temperatures and for shorter or longer time intervals, would also be suitable for the practice of this invention provided that the above-defined purpose is accomplished by the equipment.

As is known in the art, “[b]ioactive food components are constituents in foods or dietary supplements, other than those needed to meet basic human nutritional needs, that are responsible for changes in health status.”² In the present invention, the bioactive can be selected from both plant and animal sources or can be synthetically produced. Particularly preferred are medium chain fatty acids, omega-3 fatty acids, omega-6 fatty acids, omega-7 fatty acids, omega-9 fatty acids, vitamins, cannabinoids, herbals or other botanicals, amino acids, dietary substances for use by man to supplement the diet by increasing the total dietary intake and concentrates, metabolites, constituents or extracts and derivatives thereof.

The present invention provides a triglyceride oil-in-glycerin emulsion for use as is (ingested orally by mouth) or as an ingredient in a food or dietary supplements (in which case the emulsion may be diluted). This emulsion is preservative-free and readily diluted with water. Moreover, the process of manufacturing the present invention does not generate any reaction of triglyceride oil to free fatty acids, which can affect taste (see Example 3 below).

Advantages of the present invention include the fact that it meets food certifications, is able to contain bioactives, and is non-toxic. Its color, aroma, taste and texture are generally acceptable to consumers. In addition, it is naturally sweet and prevents dental cavities because it is sugar-free. The invention may be used as a spread on bread/toast or mixed into yogurt or other dairy products for rapid uptake physiologically. The triglyceride oil-in-glycerin emulsion consist of simple, clean-label ingredients and are easy to prepare.

### Example 1: Exemplary of Liquid Coconut Oil in Glycerin Emulsion

The triglyceride oil-in-glycerin emulsion composition of liquid coconut oil and glycerin with ratio of 1.6 to 1 on a weight basis was prepared using the present invention. The material, amounts and in-process testing are listed in Table 1.

TABLE 1

| | Quantity |
|---|---|
| Description | (Kg) |
| Liquid Coconut Oil | 6.0 |
| Glycerin | 3.7 |
| Lecithin | 0.3 |
| Total | 10.0 |

In-Process Testing

| | |
|---|---|
| Finished emulsion appearance | Uniform |
| Dispersion into water | <10 sec. |
| Centrifugation at 3,000 | No Separation |
| rpm for 15 min | |
| Acid Value | 1.2 |

In a typical practice of the present invention, the liquid coconut oil and lecithin were heated to 70° C. in a side container. In a primary container, glycerin was heated to 70° C. While mixing with a high-shear impeller speed of 500 rpm, the triglyceride mixture was slowly transferred from the side container to the primary container by pouring into the vortex of the mixing. High-shear mixing may be performed with any mixer, blender, homogenizer, etc. that is used for producing emulsions. The triglyceride mixture was transferred over about 30 minutes. As the volume increased in the primary container, the impeller speed was slowly increased from 500 rpm to 3,000 rpm. Once the transfer was completed, the emulsion was mixed for an additional 10 minutes. The emulsion was then cooled in a water bath to 40° C. and discharged into a mini-tote.

### Example 2: Exemplary of Process Temperature on Liquid Coconut Oil in Glycerin Emulsion

A series of experiments, Table 2, compares the present invention at different processing temperatures.

TABLE 2

| Process | 60° C. | 70° C. | 80° C. |
|---|---|---|---|
| Add lecithin to oil | 25° C. | 25° C. | 25° C. |
| Heat oil phase | 60° C. | 70° C. | 80° C. |
| Heat glycerin phase | 60° C. | 70° C. | 80° C. |
| While mixing, slowly | 500-3,000 rpm | 500-3,000 rpm | 500-3,000 rpm |
| add oil phase to | 60° C. | 70° C. | 80° C. |
| glycerin phase | 30 min | 30 min | 30 min |
| Continue mixing | 3,000 rpm | 3,000 rpm | 3,000 rpm |
| | 60° C. | 70° C. | 80° C. |
| | 10 min | 10 min | 10 min |
| Cool | With or | With or | With or |
| | without | without | without |
| | mixing | mixing | mixing |

In-Process Test ng

| | | | |
|---|---|---|---|
| Finished emulsion | Separation | Uniform | Uniform |
| appearance | | | |
| Dispersion in water | >5 min | <10 sec | <10 sec |
| Centrifugation at 3,000 | Separation | No | No |
| rpm for 15 min | | separation | separation |

From the above results, the emulsion appearance, dispersion into water, and centrifugation testing for the 60° C. showed separation, instability, and no dispersion in water. Simply increasing the processing temperature to 70° C. to 80° C. resulted in a stable emulsion.

### Example 3: Exemplary of Liquid Coconut Oil Hydrolysis

This example examines the effect of hydrolysis of triglycerides in two liquid coconut emulsions, the present invention and a water emulsion, stored at room temperature for a defined time interval. The two emulsions were prepared as per typical practice and evaluated for acid value at room temperature at various time intervals. Acid value is commonly used to measure the amount of free fatty acids hydrolyzed from a triglyceride oil structure. Acid value is defined as the weight of potassium hydroxide in mg need to neutralize the organic acids.

TABLE 3

| | Quantity | Quantity |
|---|---|---|
| Description | (Kg) | (Kg) |
| Liquid Coconut Oil | 60.0 | 50.0 |
| Glycerin | 37.0 | — |
| Water | — | 43.7 |
| Lecithin | 3.0 | — |
| Gum Arabic | — | 6.2 |
| Sorbic Acid | — | 0.1 |
| Total | 100.0 | 100.0 |

Acid value testing at room temperature

| | | |
|---|---|---|
| 0 time | 1.0 | 1.2 |
| 4 month | 0.9 | — |
| 6 month | 0.8 | 2.4 |
| 24 month | — | 4.4 |

In Table 3, the acid values for the triglyceride oil-in-water showed an increasing acid value as a function of time, whereas the triglyceride oil-in-glycerin did not show changes in the acid value.

### Example 4: Exemplary Self-Preserving of Liquid Coconut Oil in Glycerin Emulsion

In this example, the triglyceride oil-in-glycerin composition underwent preservative challenge testing. Samples of composition are inoculated with several varieties of bacteria and fungi and then regularly evaluated during the testing period for levels of contamination.

TABLE 4

| | Positive | Day 0 | Day 7 | Day 14 | Day 21 | Day 28 |
|---|---|---|---|---|---|---|
| Microorganism | Control | (count) | (count) | (count) | (count) | (count) |
| Candida albicans | 1 × 10⁵ | 1.0 × 10⁴ | <10 | <10 | <10 | <10 |
| Aspergillus niger | 1.0 × 10⁵ | 4.0 × 10² | 4.0 × 10² | 4.0 × 10² | <10 | <10 |
| Escherichia coli | 4.0 × 10⁷ | 8.0 × 10⁵ | <10 | <10 | <10 | <10 |
| Pseudomonas | 1.0 × 10⁷ | 7.0 × 10⁵ | 4 × 10⁴ | <10 | <10 | <10 |
| aeruginosa | | | | | | |
| Staphylococcus aureus | 7.0 × 10⁷ | 1.0 × 10⁶ | <10 | <10 | <10 | <10 |

In Table 4, preservatives were not required to prevent the growth of microbiological contaminants and otherwise deteriorate and compromise the product.

### Example 5: Exemplary of Bioactives in Liquid Coconut Oil-in-Glycerin Emulsion

In this example, a CoQ10 bioactive is dissolved in liquid coconut oil, and an L-carnitine bioactive is dissolved in glycerin. The triglyceride oil-in-glycerin emulsion was prepared using the present invention.

TABLE 5

| | Quantity |
|---|---|
| Description | (Kg) |
| CoQ10 | 1.89 |
| Liquid Coconut Oil | 56.23 |
| L-Carnitine | 1.89 |
| Glycerin | 37.00 |
| Lecithin | 3.00 |
| Total | 100.00 |

### Example 6: Industrial Manufacturing of Liquid Coconut Oil-in-Glycerin Emulsion

In this example, the triglyceride oil-in-glycerin emulsion of liquid coconut oil triglycerides and glycerin with ratio of 1.6 to 1 on a weight basis was prepared using the present invention. The material and amounts are listed in Table 6.

TABLE 6

| | Quantity |
|---|---|
| Description | (Kg) |
| Liquid Coconut Oil | 885 |
| Glycerin | 555 |
| Lecithin | 45 |
| Vanilla flavor | 15 |
| Total | 1,500 |

In-Process Testing

| | |
|---|---|
| Finished emulsion appearance | Uniform |
| Dispersion into water | <10 sec. |
| Centrifugation at 3,000 | No Separation |
| rpm for 15 min | |
| Acid Value | 0.9 |

In a typical practice of the present invention, the liquid coconut oil triglyceride and lecithin were heated to 80° C. in a side tank. In a primary tank, glycerin was heated to 80° C. Using a 32-inch impeller and an impeller speed of 50 rpm in a mixer, the triglyceride mixture was transferred from the side tank to the primary tank through a progressive cavity pump such as a MOYNO™ pump. One example of a suitable mixer is the PFAUDLER™ mixer, which would typically be mounted physically on top of the tank. The triglyceride mixture was transferred over about 30 minutes. As the volume increased in the primary tank, the impeller speed was slowly increased to 90 rpm. Once the transfer was completed, the emulsion was mixed for an additional 150 minutes. The emulsion was then cooled to 40° C. Vanilla flavor was slowly added and high-shear mixing at 90 rpm continued for about 30 minutes. After mixing, the emulsion was discharged into a tote.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

### REFERENCES

1. Bancroft, W. D., The Theory of Emulsification, V, The Journal of Physical Chemistry, 17 (6): 501-519 (1913).
2. National Institute of Health, Office of Dietary Supplements. Federal Register, Vol. 69, No. 179, FR Dec 04-20892 (Sep. 16, 2004).

I claim:

1. A triglyceride oil-in-glycerin emulsion comprising:
(a) triglyceride oil in an amount equal to between forty and seventy percent of the emulsion on a weight basis;
(b) glycerin in an amount equal to between twenty and sixty percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

2. The emulsion of claim 1, wherein the triglyceride oil is selected from the group consisting of almond oil, borage oil, coconut oil, black currant seed oil, chia seed oil, camelina oil, canola oil, echium oil, evening primrose oil, flaxseed oil, hemp seed oil, sacha inchi oil, high GLA safflower oil, liquid coconut oil, pumpkin seed oil, palm oil, palm kernel oil, perilla oil, peanut oil, safflower oil, soybean oil, sunflower oil, walnut oil and wheat germ oil and combinations thereof.

3. The emulsion of claim 1, wherein the triglyceride oil is selected from an animal source of anchovies, catfish, cod, flounder, grouper, halibut, herring, mackerel, pollock, swordfish, salmon, sardines, seal oil, snapper and tuna and combinations thereof.

4. The emulsion of claim 1, wherein the triglyceride oil is selected from an algae source of docosahaexanoic acid rich oil and eicosapentaenoic acid rich oil and combinations thereof.

5. The emulsion of claim 1, wherein the triglyceride oil is selected from a microbial source of alpha linolenic acid rich oil, docosahexaenoic acid rich oil, eicosapentaenoic acid rich oil, gamma linolenic acid rich oil and linoleic acid rich oil and combinations thereof.

6. The emulsion of claim 1, wherein the triglyceride oil is selected from a synthetic source of re-esterified oil, inter-esterified mixtures of oils, medium chain triglyceride oil, plant oil concentrates and animal oil concentrates and combinations thereof.

7. The emulsion of claim 1, wherein the triglyceride oil is selected from a genetically modified organisms source of borage oil, canola oil, corn oil, evening primrose oil, flax oil, safflower oil, soybean oil, and sunflower oil and combinations thereof.

8. The emulsion of claim 1, wherein the lecithin is selected from the group consisting of crude lecithin, compounded lecithin, enzyme-modified lecithin, chemically modified lecithin, and refined lecithin.

9. The emulsion of claim 1, wherein the lecithin is derived from plant sources including sunflower, soy, corn, cottonseed, marine, rapeseed and canola.

10. The emulsion of claim 1, wherein the lecithin is de-oiled lecithin powder from sunflower containing approximately 97% phospholipids, wherein approximately 20% of the phospholipids are phosphatidylcholine.

11. The emulsion of claim 1, wherein the lecithin is selected from the group consisting of phosphatidylcholine, phosphatidylethanolamine, phosphatidylinositol, phosphatidic acid, phosphatidylserine, sphingomyelin and glycolipids.

12. A triglyceride oil-in-glycerin emulsion comprising:
(a) triglyceride oil in an amount equal to between forty-five and sixty-five percent of the emulsion on a weight basis;
(b) glycerin in an amount equal to between twenty-five and fifty-five percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

13. A triglyceride oil-in-glycerin emulsion comprising:
(a) triglyceride oil in an amount equal to between fifty and sixty percent of the emulsion on a weight basis;
(b) glycerin in an amount equal to between thirty and fifty percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

14. A triglyceride oil-in-glycerin emulsion comprising:
(a) triglyceride oil in an amount equal to between forty and seventy percent of the emulsion on a weight basis;
(b) glycerin in an amount equal to between twenty-five and fifty-five percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

15. A triglyceride oil-in-glycerin emulsion comprising:
(a) triglyceride oil in an amount equal to between forty and seventy percent of the emulsion on a weight basis;
(b) glycerin in an amount equal to between thirty and fifty percent of, the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

16. A triglyceride oil-in-glycerin emulsion comprising:
(a) triglyceride oil in an amount equal to between forty and seventy percent of the emulsion on a weight basis;
(b) glycerin in an amount equal to between twenty and fifty-five percent of the emulsion on a weight basis; and
(c) lecithin in an amount equal to between 2.5 and 7.5 percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

17. A triglyceride oil-in-glycerin emulsion comprising:
(a) triglyceride oil in an amount equal to between forty and seventy percent of the emulsion on a weight basis;
(b) glycerin in an amount equal to between twenty-five and fifty percent of the emulsion on a weight basis; and
(c) lecithin in an amount equal to between four and six percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

18. A triglyceride oil-in-propylene glycol emulsion comprising:
(a) triglyceride oil in an amount equal to between forty and seventy percent of the emulsion on a weight basis;
(b) propylene glycol in an amount equal to between twenty and sixty percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

19. A triglyceride oil-in-polyethylene glycol emulsion comprising:
(a) triglyceride oil in an amount equal to between forty and seventy percent of the emulsion on a weight basis;
(b) polyethylene glycol in an amount equal to between twenty and sixty percent of the emulsion on a weight basis; and
(c) lecithin in an amount equal to between one and ten percent of the emulsion on a weight basis;
wherein the lecithin has a hydrophilic lipophilic balance value in the range of four to seven;
wherein the lecithin contains at least ten percent phosphatidylcholine on a weight basis;
wherein the free fatty acids in the emulsion have an acid value of less than two; and
wherein the emulsion does not contain any preservatives.

20. The emulsion of claim 1, wherein the ratio of triglyceride oil to glycerin on a weight basis is in the range of 0.5 to 2.5:1.

21. The emulsion of claim 1, wherein the ratio of triglyceride oil to glycerin on a weight basis is 1.6:1.

22. The emulsion of claim 1, wherein the ratio of lecithin to glycerin on a weight basis is in the range of 0.05 to 0.30:1.

23. The emulsion of claim 1, wherein the ratio of lecithin to glycerin on a weight basis is 0.08:1.

24. The emulsion of claim 1, further comprising at least one bioactive ingredient selected from plant, animal and/or synthetically produced sources.

25. The emulsion of claim 17, wherein the bioactive is selected from the group consisting of medium chain fatty acids, omega-3 fatty acids, omega-6 fatty acids, omega-7 fatty acids, omega-9 fatty acids, amino acids, vitamins, cannabinoids, herbals and other botanicals, and concentrates, metabolites, constituents, extracts and derivatives thereof.

26. The emulsion of claim 17, wherein the bioactive is a dietary substance for use by man to increase total dietary intake.

27. A method for manufacturing a triglyceride oil-in-glycerin emulsion comprising the steps of:
(a) providing respective quantities of triglyceride oil and glycerin in a ratio of 2.5 to 0.5:1 on a weight basis;
(b) mixing lecithin containing at least ten percent phosphatidylcholine into the triglyceride oil;
(c) heating the lecithin-triglyceride oil mixture to a temperature in the range of 60° C. to 120° C.;
(d) heating the glycerin to a temperature in the range of 60° C. to 120° C.;
(e) adding the lecithin-triglyceride oil mixture to the glycerin over at least 25 minutes while stirring at successively higher speeds with a high-shear mixer;
(f) maintaining the lecithin-triglyceride oil-glycerin mixture at a temperature in the range of 60° C. to 120° C. during the mixing step; and
(g) cooling the lecithin-triglyceride oil-glycerin mixture to below 40° C. and allowing the mixture to stand undisturbed for a period of time sufficient to allow a stable emulsion to form.

28. The method of claim 27, further comprising the step of:
(h) mixing the lecithin-triglyceride oil-glycerin mixture for at least ten minutes to allow for oil droplet size uniformity.

29. The method of claim 27, wherein the step of adding the lecithin-triglyceride oil mixture to the glycerin over at least 25 minutes while stirring at successively higher speeds with a high-shear mixer comprises:
stirring the lecithin-triglyceride oil-glycerin mixture for approximately four minutes at a mixer speed of 500 rpm;
stirring the lecithin-triglyceride oil-glycerin mixture for approximately three minutes at a mixer speed of 1000 rpm;
stirring the lecithin-triglyceride oil-glycerin mixture for approximately three minutes at a mixer speed of 1500 rpm; and
stirring the lecithin-triglyceride oil-glycerin mixture for approximately 15 minutes at a mixer speed of 3000 rpm.

30. The method of claim 27, wherein the step of adding the lecithin-triglyceride oil mixture to the glycerin over approximately 25 to 30 minutes while stirring at successively higher speeds with a high-shear mixer comprises:
using a high-shear mixer fitted with impeller sizes from 0.05 to 0.80 meter; and
running the mixer at impeller tip speeds from one to ten meters per second until the mixture thickens into a homogeneous triglyceride oil-in-glycerin emulsion.

31. A method for manufacturing a triglyceride oil-in-propylene glycol emulsion comprising the steps of:
(a) providing respective quantities of triglyceride oil and propylene glycol in a ratio of 2.5 to 0.5:1 on a weight basis;
(b) mixing lecithin containing at least ten percent phosphatidylcholine into the triglyceride oil;
(c) heating the lecithin-triglyceride oil mixture to a temperature in the range of 60° C. to 120° C.;
(d) heating the propylene glycol to a temperature in the range of 60° C. to 120° C.;
(e) adding the lecithin-triglyceride oil mixture to the propylene glycol over at least 25 minutes while stirring at successively higher speeds with a high-shear mixer;
(f) maintaining the lecithin-triglyceride oil-propylene glycol mixture at a temperature in the range of 60° C. to 120° C. during the mixing step; and
(g) cooling the lecithin-triglyceride oil-propylene glycol mixture to below 40° C. and allowing the mixture to stand undisturbed for a period of time sufficient to allow a stable emulsion to form.

32. The method of claim 27, further comprising the step of:
(h) mixing the lecithin-triglyceride oil-propylene glycol mixture for at least ten minutes to allow for oil droplet size uniformity.

33. The method of claim 27, wherein the step of adding the lecithin-triglyceride oil mixture to the propylene glycol over at least 25 minutes while stirring at successively higher speeds with a high-shear mixer comprises:
stirring the lecithin-triglyceride oil-propylene glycol mixture for approximately four minutes at a mixer speed of 500 rpm;
stirring the lecithin-triglyceride oil-propylene glycol mixture for approximately three minutes at a mixer speed of 1000 rpm;
stirring the lecithin-triglyceride oil-propylene glycol mixture for approximately three minutes at a mixer speed of 1500 rpm; and
stirring the lecithin-triglyceride oil-propylene glycol mixture for approximately 15 minutes at a mixer speed of 3000 rpm.

34. The method of claim 27, wherein the step of adding the lecithin-triglyceride oil mixture to the propylene glycol over approximately 25 to 30 minutes while stirring at successively higher speeds with a high-shear mixer comprises:
using a high-shear mixer fitted with impeller sizes from 0.05 to 0.80 meter; and
running the mixer at impeller tip speeds from one to ten meters per second until the mixture thickens into a homogeneous triglyceride oil-in-propylene glycol emulsion.

35. A method for manufacturing a triglyceride oil-in-polyethylene glycol emulsion comprising the steps of:
(a) providing respective quantities of triglyceride oil and polyethylene glycol in a ratio of 2.5 to 0.5:1 on a weight basis;
(b) mixing lecithin containing at least ten percent phosphatidylcholine into the triglyceride oil;
(c) heating the lecithin-triglyceride oil mixture to a temperature in the range of 60° C. to 120° C.;
(d) heating the polyethylene glycol to a temperature in the range of 60° C. to 120° C.;
(e) adding the lecithin-triglyceride oil mixture to the polyethylene glycol over at least 25 minutes while stirring at successively higher speeds with a high-shear mixer;
(f) maintaining the lecithin-triglyceride oil-polyethylene glycol mixture at a temperature in the range of 60° C. to 120° C. during the mixing step; and
(g) cooling the lecithin-triglyceride oil-polyethylene glycol mixture to below 40° C. and allowing the mixture to stand undisturbed for a period of time sufficient to allow a stable emulsion to form.

36. The method of claim 27, further comprising the step of:
(h) mixing the lecithin-triglyceride oil-polyethylene glycol mixture for at least ten minutes to allow for oil droplet size uniformity.

37. The method of claim 27, wherein the step of adding the lecithin-triglyceride oil mixture to the polyethylene glycol over at least 25 minutes while stirring at successively higher speeds with a high-shear mixer comprises:
stirring the lecithin-triglyceride oil-polyethylene glycol mixture for approximately four minutes at a mixer speed of 500 rpm;
stirring the lecithin-triglyceride oil-polyethylene glycol mixture for approximately three minutes at a mixer speed of 1000 rpm;
stirring the lecithin-triglyceride oil-polyethylene glycol mixture for approximately three minutes at a mixer speed of 1500 rpm; and
stirring the lecithin-triglyceride oil-polyethylene glycol mixture for approximately 15 minutes at a mixer speed of 3000 rpm.

38. The method of claim 27, wherein the step of adding the lecithin-triglyceride oil mixture to the polyethylene glycol over approximately 25 to 30 minutes while stirring at successively higher speeds with a high-shear mixer comprises:
using a high-shear mixer fitted with impeller sizes from 0.05 to 0.80 meter; and
running the mixer at impeller tip speeds from one to ten meters per second until the mixture thickens into a homogeneous triglyceride oil-in-polyethylene glycol emulsion.
